(19) United States
(12) Patent Application Publication
(10) Pub. No.: US 2010/0176038 A1
(43) Pub. Date: Jul. 15, 2010

(54) CHEMICAL ADDITIVE APPARATUS AND METHODS

(76) Inventors: Matthew S. Hayas, Cincinnati, OH (US); Matthew D. Horine, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 12/690,338

(22) Filed: Jan. 20, 2010

Related U.S. Application Data
(63) Continuation-in-part of application No. 12/184,339, filed on Aug. 1, 2008, now abandoned.

(51) Int. Cl. C02F 1/00

(52) U.S. Cl. 210/96.1

(57) ABSTRACT

Chemical additive preferably derived from a solid chemical concentrate is selectively educted into the closed water recirculation or makeup line of a water system. In one embodiment, a bypass line is controlled by a valve to direct system water through the eductor when chemical additive is desired, and at least a portion thereof around the eductor when no chemical additive is desired. Open line application is disclosed. In other embodiments, single or multiple, selectively operated eductors are used without any bypass line. In these embodiments, any time water flows through the chemical additive apparatus, water is treated.

### PRIORITY CLAIM

This application is a Continuation-in-Part of prior U.S. patent application Ser. No. 12/184,339, filed Aug. 1, 2008, the benefit of such filing date is claimed. Such parent application is expressly incorporated herein by reference.

### BACKGROUND OF THE INVENTION

This invention relates to liquid treatment and more particularly, to apparatus and methods for treating system liquids with chemical additives. Even more particularly, the invention has special application to the treatment of a variety of water systems with chemical additives.

In the past, it is known to pump chemical additives into water system. As an example, cooling towers typically include a closed water circulation line running through a water or cooling tower and a heat exchangers such as for air conditioning. Other water systems may include boil, waste water, closed water, potable water, swimming pool, hot tub and other system. In such systems, a closed water line circulates through components of the system.

Water and particularly untreated water typically carries with it certain chemical content which can corrode the water lines, or cause unwanted buildup, thus causing flow restrictions, leaks, breakdowns, stoppages, over pressures or the like. In addition, use of untreated water in certain systems may lead to undesirable health-related consequences or issues. To prevent these undesirable consequences, it has been known to pump chemical additives into these closed water lines to treat the water and prevent the expected corrosion, buildup or health-related issues.

In more sophisticated known systems, the water is analyzed, such as by conductivity sensing, to provide a signal responsive to its condition, content or status. Such signals are processed to control one or more pumps, such as diaphragm pumps, to pump desired chemicals into the water at a rate responsive to the sensed condition of the water system.

Presently, a water system manager has two forms of chemical sources for use with such a system. Typically, the chemical additives are provided in either liquid form, which is the major portion of the market, or in solid form. While the solid form has numerous operational advantages, it presents inherent considerations which have limited its use and expansion in the marketplace. In the case of the solid form, a dissolver is typically used to reduce the solid chemical to a liquid form for pumping into a water system through the diaphragm pumps noted above. It is the nature of that liquid mixture which has previously limited the wider use of the solid form of additive.

A difference in the solid and liquid supply formats is that of active chemical concentration. In the liquid format, such concentration is about ten to about twenty percent. In the liquid mixture, reconstituted from a solid concentrate form of chemical, the concentration may be about one-half to about one percent. Accordingly, the liquid additive source contains an active chemical about ten to about forty times the active content of the liquid mixture obtained from the solid chemical supply form. At the pumped rate of about one gallon of liquid per hour into the system, the active concentration of chemical from the solid form supply may not be of sufficient concentration to be effective for the desired purpose.

Accordingly, whatever the base form or source of additive or liquid, both either are liquid or are reduced to liquid, then pumped into the water system at desired rates and concentrations.

Both are typically pumped into the water system with which they are used. These pumps may be of a variety of configurations. Such pumps may be peristaltic or diaphragm pumps or other forms of typically heavy construction and of significant expense in relation to the system. Such pumps must be maintained and usually have a finite life or cycle time, at the end of which they must be replaced.

In one typical diaphragm pump system, for example, the diaphragm pumps are generally capable of pumping about one gallon per hour into the water system. Thus, the total liquid treating mixture from a liquid source which can be added to the system over 24 hours is about 24 gallons. Where a solid additive source is used, at the same one gallon per hour rate, the total active chemicals which can be added to the system is thus significantly less than the amount of additives presented to the system where a liquid additive source, at its higher active concentration, is used. This inherent circumstance has created a market wherein the powder or solid source products, at their lower active component concentration, are at a significant competitive disadvantage, despite their other advantages which are numerous.

The advantages of using a solid state additive source, however, apart from their available concentration levels are significant. These include the ease of using a solid as compared to a liquid. Fewer spills are experienced with the solids sources and these, if any, are much more readily cleaned up. Safety is improved as liquids are more difficult to handle and if leaked or spilled from their containers when stored or when unloaded into the pumps. Contact with the solid source is more easily avoided, and more easily resolved if skin contact is made.

Moreover, the pumps used in both solid or liquid source systems have finite lives, require maintenance or replacement and are expensive. And when the water systems to be treated are very large, much larger and more expensive additive pumps are required.

Accordingly, it is desirable to facilitate the use of solid chemical additives in water treatment systems.

It is also desirable to provide improved water treatment systems for adding chemical additives to a water system.

It is further desirable to provide a water treatment system using a solid chemical additive source but capable of providing active chemical compounds at an even higher concentration, over time, rather than prior pump systems using liquid chemical additive sources.

It is also desirable to provide an improved chemical additive apparatus and methods for a water system when pumps of traditional configuration are eliminated.

To these ends, an improved water treatment apparatus according to one embodiment of the invention includes an eductor spliced into a pressurized water system line preferably on the pump outlet side of a closed water system. A valve upstream of the eductor has one position where water in the system is directed through the eductor. In another position, the valve directs system water flow around the eductor and into the closed water system downstream of the eductor.

The eductor is connected to a source of chemical additives preferably produced by a dissolver acting to dissolve a solid chemical additive source to a liquid mixture state. This liquid is drawn up into, and mixed with, the system water to be treated at a rate which significantly exceeds that of liquids pumped into the system by the prior additive devices. In particular, the eductor as used in the preferred embodiment noted above is capable of supplying not one gallon per hour as with a pump, but up to about sixty gallons of liquid chemical additive per hour into the system. At such a rate, the active chemical added to the system can far exceed the effective concentration added by the prior pumped system even where a liquid additive source, itself having a higher chemical concentration, is used. For example, even at the low one half percent active component concentration for a solid additive source, a significant amount of chemical additive can be added per hour (at sixty gallons per hour), well beyond the prior pumped systems where only about one gallon per hour was attained.

While these new apparatus and methods could, of course, be used to add chemical from a liquid source, the invention will find significant use in enabling water system owners and managers to treat their systems from a solids additive source, with sufficient additives for system maintenance and corrosion preventance while attaining the advantages of a solids additive source. No longer is it necessary to use a liquid source to attain a desired level of chemical additive concentration. In fact, even higher concentrations can be attained over time as compared with liquid additive pumped systems.

Moreover, such new apparatus and methods can be used in large pressurized water systems, without the need of expensive large additive pumps or the energy to drive them.

These and other advantages will be readily ascertained from the following written description of a preferred embodiment and from the drawings in which:

### BRIEF DESCRIPTION OF THE DRAWINGS

FIG. 1 is a diagrammatic illustration of a water system modified by the addition of a water treatment apparatus according to the invention;

FIG. 2 is an enlarged perspective view of the eductor and bypass apparatus of FIG. 1;

FIG. 3 is a perspective view of a dissolver board system as in FIG. 1;

FIG. 4 is a schematic diagram illustrating operation of the invention where chemical is being added to a water system;

FIG. 5 is a schematic view similar to FIG. 4 but illustrating operation of the invention where system water is bypassed around the eductor with no chemical being added to the water system;

FIG. 6 is a diagrammatic illustration of an alternate embodiment of the invention of FIG. 1; and

FIG. 7 is an elevational view of a triple eductor, chemical additive apparatus modification of the system of FIG. 6.

### DETAILED DESCRIPTION OF A PREFERRED EMBODIMENT

Turning now to the Figures, it will be appreciated that the invention is directed to apparatus for introducing chemical additive to a water line system such as a water tower, cooling tower, boiler, waste water, potable water swimming pool, hot tub or other water line system where chemical may be added to water flowing under pressure in a closed water line. This is opposed to an open-line system where eductors are used to add chemical to a water flowing in an essentially open line system, such as in a chemical proportioner and dispenser for producing a mixture for cleaning, sanitation, foaming, for example, and wherein the only water pressures are incidental to the inherent pressures of water being released to atmosphere through an eductor.

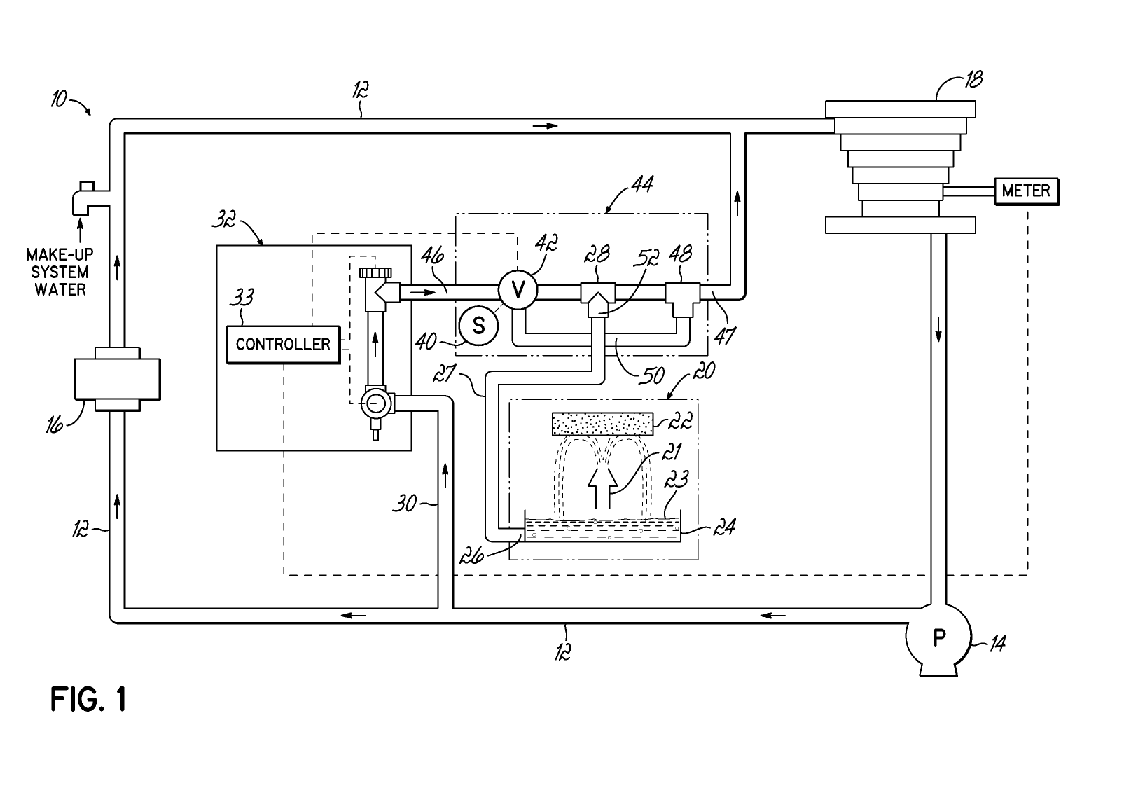

FIG. 1 illustrates a water system 10 having a closed water line 12 circulating water from pump 14 through a heat exchange and cooling tower 18.

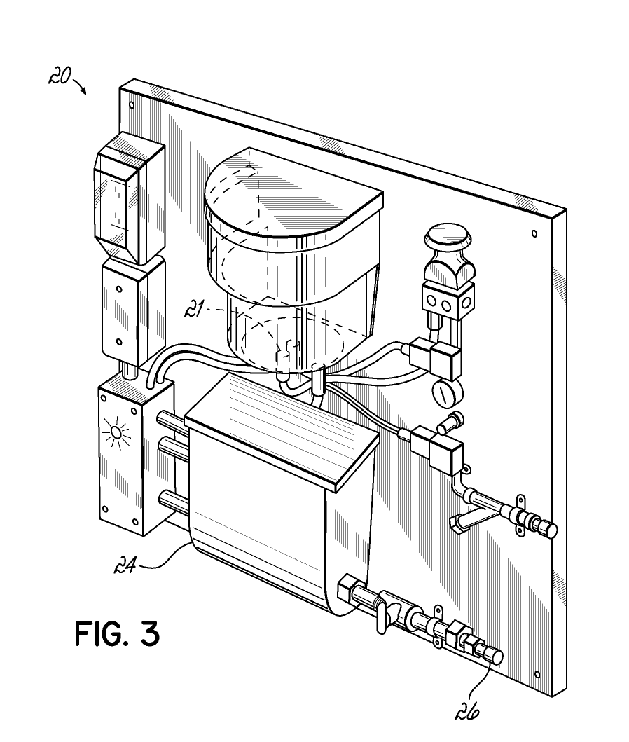

A dissolver board 20 is provide with a nozzle 21 for spraying water onto a solid chemical concentrate supply in the form of a block 22 to generate a liquid mixture 23 of water and chemical collected in a reservoir 24. A liquid outlet 26 from reservoir 24 is operably connected to an eductor 28 through line 27. The dissolver board 20 may be any suitable type and could be as described in U.S. Pat. No. 6,820,661 or in United States Publication No. 2007/0269894A1, published on Nov. 22, 2007 and entitled “Solution Dispensing System”. Both documents are expressly incorporated herein by reference as if fully and expressly described in their entirety herein. Any suitable apparatus for converting or reducing the solid chemical supply 22 to a liquid mixture 23 can be used. For example, the dissolver board 20 depicted in FIG. 3 is like that described in FIG. 1 of U.S. Pat. No. 6,820,661 and reference is made therefor for clarity. In addition, the additive diluted from a solid mix can be supplied from any source such as a dilution bowl, drum, pail, tote or other source than a reservoir from a dissolver system. The word “reservoir” is thus herein used broadly without limitation to a particular container and a dissolver board. The chemical so supplied may also come from any form such as a solid or from a liquid form, if desired, and whether in prepared form or mixed onsite.

FIG. 1 further illustrates a water line 30 connected to line 12 for diverting water and line pressure to a water analysis apparatus 32 including a controller 33. Water flowing through apparatus 32 is sensed or analyzed to indicate a condition of the water with respect to its chemical content. The analysis in response to the sensed condition of the system water generates a controller signal which is transmitted to a solenoid 40 connected to operate valve 42 as will be described.

It will be appreciated that any suitable form of water analysis apparatus 32 and controller could be used, such as those shown in U.S. Pat. No. 6,418,958, expressly incorporated herein by reference, in aforesaid United States Patent Publication No. US2007/0269894A1, also incorporated herein by reference, or any other suitable form of water analysis or condition detecting apparatus.

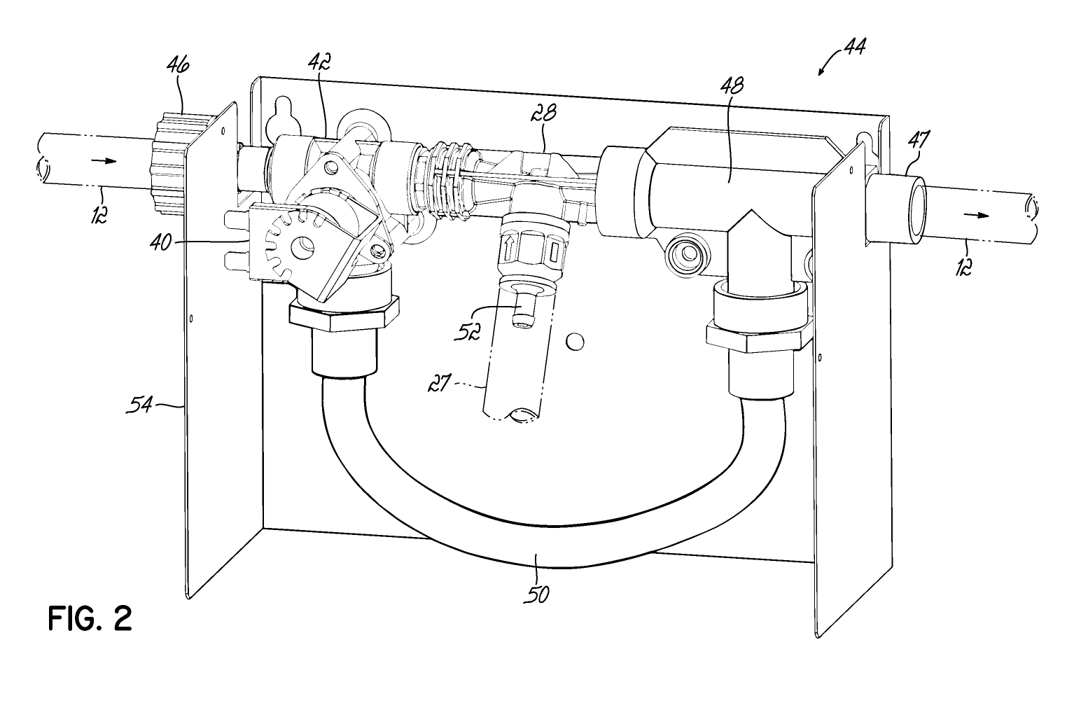

Turning now to FIG. 2, there is illustrated therein the apparatus which is operable to either draw chemical additive into system water flowing therethough or to bypass the eductor when no additive is required.

An additive apparatus 44, according to one embodiment of the invention as shown in FIG. 2, includes an input 46 for connection to water line 30 from water analysis apparatus 32, a water line output port 47, a valve operating solenoid 40, a valve 42, an eductor 28, a bypass connector 48, a bypass line 50 and an eductor input port 52 for connection to a chemical additive through line 27, in the preferable form of a liquid mixture 23 reduced from a solid chemical concentrate form 22. These components may be mounted on or supported by a bracket apparatus 54 or other mounting apparatus as desired for supporting them conjunction with a water system 10.

Valve 42 is of any suitable type valve having at least an input operably connected to receive water from line 12 and input 46 and two outlets. One outlet is operably connected to eductor 28 and the other outlet to bypass line 50.

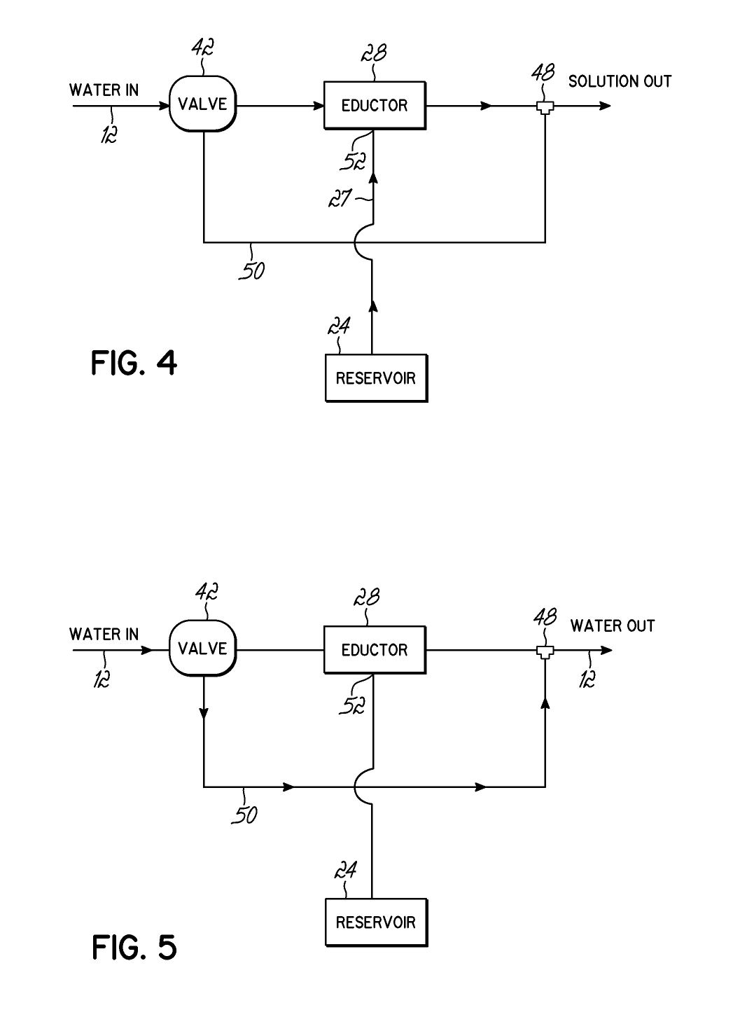

In FIGS. 4 and 5, the operative flow of system water is shown by the arrows in those respective figures. In one condition, solenoid 40 moves valve 42 to direct water from line 12 to bypass line 50, around eductor 28, and to line 12, all without passing water through eductor 28 (FIG. 5). In another condition, solenoid 40 moves valve 42 to a position where water is directed to eductor 28. Bypass line 50 is closed (FIG. 4). In this condition, water flowing through eductor 28 creates suction in the eductor, operable to draw liquid chemical additive mixture through port 52. Additive is drawn into system water flowing through and from eductor 28, through connector 48 and into closed water line 12.

It will be appreciated that in typical water systems having closed water lines 12, pressures are typically within the range of about 40 psi to about 80 psi. For these ranges, an eductor 28 is selected which is capable of adding from about one gallon per hour to about sixty gallons per hour of liquid chemical additive and preferably about one to about ten gallons per hour. Various known eductors, metering orifices and other eductor parameters or accessories can be used to produce the desired chemical flow for any given system when additive is desired.

It will of course, be appreciated that solenoid 40 is preferably operated in response to a signal generated by the sensed condition of system water. Alternatively, a controller operating solenoid 40 might be programmed to automatically operate solenoid 40 and valve 42 in a predetermined fashion such as in predetermined time intervals or periods, or in response to a signal initiated by a timer. Also, the solenoid 40 and valve 42 could be operated in response to a signal derived from a water meter (including a reading therefrom). In a yet further alternative, the solenoid may be replaced with a servo-type valve operator to control a proportional operation of a valve 42 configured to pass some system water through eductor 28 and some system water simultaneously through bypass line. This could be used to facilitate control of the ratio of liquid chemical additive to system water as may be desired.

It will be further appreciated that dilution rates could be varied from about 3:1 to about 4,000:1 and could be greater than one million to one.

In an alternate embodiment, the apparatus 44 could be operatively connected into a makeup water line instead of a recirculation line as shown in the FIGS. In such an alternative, the solenoid 40 may be eliminated and all incoming water treated without need of a bypass line.

In yet other alternate embodiments, the solenoid may be any of normally closed, normally open or three way solenoids. A manually or pneumatically operated valve could be used in place of an electrically operated valve 42. Moreover, as noted above, signals from a timer, controller or water meter could be used to operate valve 42.

In yet a further aspect of the invention it will be appreciated that valve 42 could be controlled by any suitable expedient in one position to only partially throttle the eductor 28, such that when no additive is desired, water flow is shut off sufficiently to prevent creation of suction and resulting induction of chemical through the eductor, but some water flow through the eductor, insufficient to draw up chemical additive, is continued.

In yet a further aspect of the invention, it will be appreciated that when no additive is desired, the feed line from the chemical source could be blocked, such as by a valve, while water flow through eductor 28 was continued.

Accordingly, the invention is useful to provide chemical additive from a solid chemical concentrate to a water system at a rate sufficient to have the desired additive effect and without the use of mechanical pumps. Benefits of using a solid additive supply are attained without undue concern over the rate of active additive input.

While the preferred embodiment and use of the invention, which contemplates the unique combination of an eductor and a selective eductor bypass, has been described in connection with a closed or pressurized water system, the invention in another aspect might be used for water or other diluent treatment systems of an open line configuration where the eductor effluent and the selective bypass effluent are discharged into a non-pressurized environment such as an open tank or other open facility. Accordingly, the invention could be used in similar ways as that described above for an even wider variety of treatment systems and with the use of dilutions from either solid or liquid concentrated chemical sources.

### Alternate Embodiments and Modifications

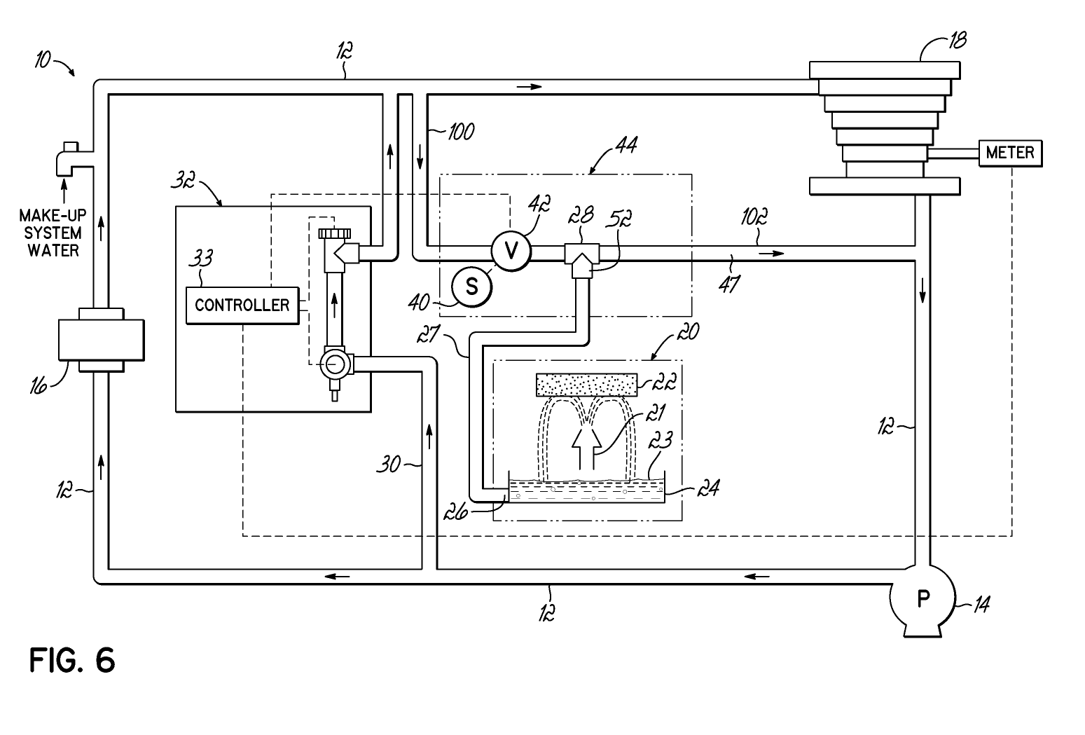

An alternate embodiment is illustrated in FIG. 6 which is a schematic illustration of a modified chemical additive apparatus. In this embodiment, like elements to those of FIGS. 1-5 are above-identified with like numbers.

In the prior embodiments of FIGS. 1-5, the respective water analysis and controller apparatus and chemical additive apparatus are connected in series across the closed water circulation loop (line 12) from just downstream of pump 14 to just upstream of cooling tower 18. Water first flows from loop 12 through water analysis apparatus 32, then through additive apparatus 44 before re-entering loop 12, as shown in FIG. 1.

In this alternate embodiment of FIG. 6, the water analysis apparatus 32 and the chemical additive apparatus 44 are connected across loop 12 in parallel. Water flows from loop 12 downstream of pump 14, through water analysis apparatus 32 directly back to loop 12 upstream of cooling tower 18. Water does not directly flow from apparatus 32 to additive apparatus 44.

Instead, additive apparatus 44 itself has an input pipe 100 connected to a closed water circulation loop 12 upstream of cooling tower 18. Water flows through additive apparatus 44, is selectively treated as commanded by water analysis apparatus 32 and then treated water discharged in pipe 102 to closed recirculation loop 12 as shown in FIG. 6.

In this embodiment, water constantly flows through analysis apparatus 32 (it could optionally be valved). There is, however, no additive bypass circuit around eductor 28 as there is in FIG. 1. Instead, water can constantly flow through loop 12, pressurizing line 100, but there is no flow through additive apparatus 44 unless valve 42 is opened by solenoid 40 on command from controller 33. Accordingly, there is an independent and separate water flow circuit through analysis apparatus 32 and another through additive apparatus 44. It will be appreciated that any time water flows through pipe 100 and additive apparatus 44, chemical is drawn through eductor 28 and treated water is introduced to the loop 12. There is no bypass of water in additive apparatus 44 around eductor 28.

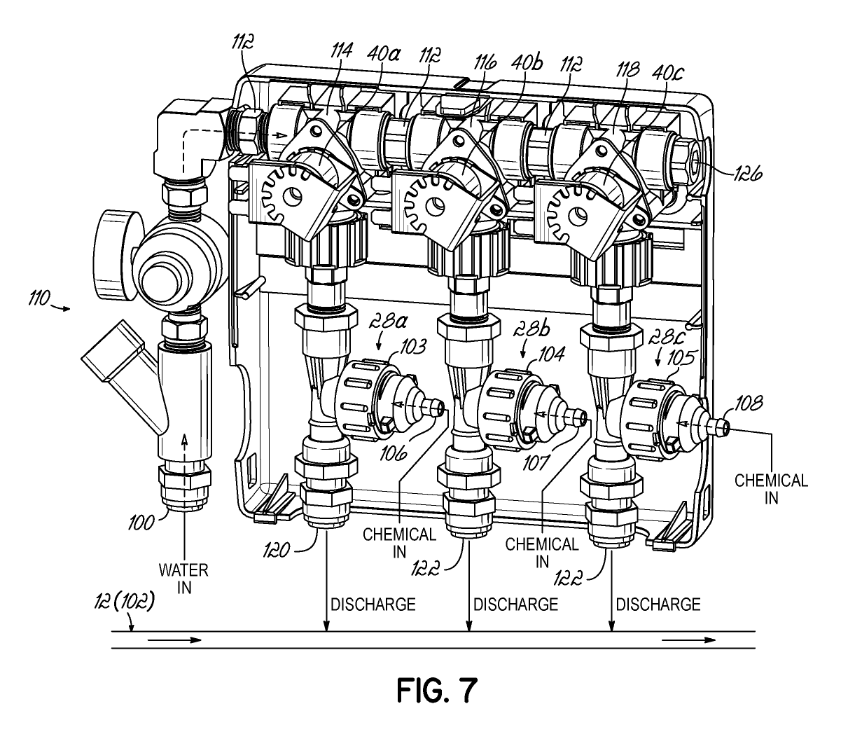

A modification to the embodiment of FIG. 6 is illustrated in FIG. 7. In some applications, it is desirable to have the capability of introducing more than one additive to the circulating water. In this modification to provide such a function, three eductors 28a, 28b and 28c (FIG. 7) are substituted for the eductor 28 of FIG. 6. Each eductor 28a, 28b and 28c is operably interconnected via a check valve 103, 104, 105 to a chemical inlet 106, 107, 108, respectively. Each such inlet is operably connected to a chemical source (not shown in FIG. 7) providing chemical in liquid form, preferably from a dried concentrate dissolver (FIG. 6) as otherwise described herein.

An inlet pipe 100 receives water from loop 12 (FIG. 6) and passes it through a reducer and a filter shown at 110 of any suitable form. From there, water flows through a manifold or pipe 112 which has three outlets controlled by respective solenoid (40a, 40b, 40c) operated valves 114, 116 and 118. When opened, each respective valve passes water from pipe 112 to a respective eductor 28a, 28b, 28c for drawing liquid chemical from a respective source (not shown in FIG. 7, but see FIG. 6) through respective inlets 106, 107, 108, either individually, sequentially or simultaneously.

Treated water flows through selectively opened eductors 28a, 28b, 28c and from respective discharge outlets 120, 122, 124 back to loop 12, shown diagrammatically in FIG. 7. Discharge can be into pipe 12 at different input locations, or through a common discharge pipe 102 (FIG. 6).

Since pipe 112 is plugged at 126, water in pipe 112 flows through an eductor 28a, 28b, 28c only when one or more valves 114, 116, 117 are selectively opened by respective solenoids 40a, 40b, 40c. Any time water flows through pipe 112 into any of these eductors connected to chemical source, water is treated and discharged into loop 12. There is no bypass.

Various aspects of the modified embodiment of FIG. 7 will be readily appreciated.

Each of the three eductors 28a, 28b, 28c are preferably vertically mounted with a vertical discharge direction and controlled by a dedicated, individual solenoid and associated valve.

Each of the eductors is provided with a respective check valve 103, 104, 105 to prevent backflow into a respective chemical source.

The discharge of each eductor may be separately connected to loop 12 or to a common discharge pipe 102, connected to loop 12, and preferably where the line pressure at line 12 is less than about 25 psi.

A water analysis apparatus 32 controls each solenoid 40a, 40b, 40c independently. Alternatively, a timer or other programmer can be used to control these solenoids.

There is no bypass circuit in the additive apparatus 44, nor in the structure of FIG. 7.

Finally, and optionally, the eductor discharge could be directed into an open, non-pressurized sump.

While a variety of system parameters could be optimized, it should be appreciated that the embodiments described herein are particularly useful where eductor inlet pressures are in the approximate range of 20-90 psi and preferably 40-90 psi. The discharge produced by the eductors is operable against a maximum back pressure in the approximate range of 25 psi (where the eductor inlet pressure is 40 psi) to 45 psi (where the eductor inlet pressure is 90 psi). Higher back pressures (such as in lines 102, or 12, for example, in a closed-loop system) require higher inlet pressures. The relationship of required inlet pressure to actual back pressure for efficient eductor operability is non-linear, but according to the invention falls within these accepted ranges for a large variety of practical applications in existing water systems. Eductors and the parameters thereof can be designed by routine testing for other pressure ranges and any suitable eductors providing sufficient chemical flow into the water diluent at prescribed eductor inlet and back pressures can be utilized.

It should also be appreciated that, if desired, independent and separately controlled pumps could be used in place of the eductors.

Finally, while the invention is particularly useful in closed loop, water circulation systems, other use in open, non-pressurized systems is contemplated in particular applications. Also, any chemical source and any eductor may be connected to a water makeup line instead of directly to a loop or circuit 12.

With the embodiments of FIGS. 6 and 7, for example, a chemical reservoir 24 can be located up to about fourteen feet from the eductor, although about seven feet distance is preferred. The eductor discharge point into a closed loop system operating in the pressure ranges contemplated herein can be up to about 35 feet above the eductor location. These preferred operating parameters render the invention particularly useful where system access is problematic, such as in retrofits.

These and other modifications will become readily apparent from the foregoing to one of ordinary skill in the art without departing from the scope of the invention and applicant intends to be bound only by the claims appended hereto.

What is claimed is:

1-18. (canceled)

19. Treatment apparatus for a water system and including:
a water analysis apparatus operably connected across a water loop of a water system;
at least one eductor operably and selectively connected a cross said loop in parallel with said water analysis apparatus for drawing chemical from a chemical supply into said closed water line when water runs through said eductor.

20. Treatment apparatus as in claim 19 further including a valve operably connected to said at least one eductor, said valve operably connected to said water analysis apparatus and selectively operable to operate said valve and pass water to said at least one eductor.

21. Treatment apparatus as in claim 20 wherein said valve has an inlet connected to said water loop and a single outlet connected directly to said at least one eductor.

22. Treatment apparatus as in claim 21 wherein said eductor has an inlet and water at said inlet is in a pressure range of about 20 psi to about 90 psi.

23. Treatment apparatus as in claim 22 wherein said pressure is in the range of 40 psi to 90 psi.

24. Treatment apparatus as in claim 23 wherein said eductor has a discharge outlet connected to a water line wherein water pressure in said line at said discharge outlet is in the range of 25 psi to 45 psi.

25. Treatment apparatus as in claim 19 further including at least two eductors.

26. Treatment apparatus as in claim 25 including three eductors each selectively operable to draw chemical into a flowing water stream and to discharge chemically treated water.

27. Treatment apparatus including a discharge outlet from each eductor, said respective discharge outlets operably connected to a water system water line.

28. Treatment apparatus for a water system and including:
a water analysis apparatus operably connected to a water line in said water system;
a plurality of eductors, each having a water inlet, and selectively and operably coupled to respective sources of chemical and to said water analysis apparatus for selectively drawing chemical into a water stream flowing through said respective eductors;
a plurality of valves, each operable connected to selectively flow water to an inlet of a respective one of said eductors in response to operation of said water analysis apparatus;
each respective valve having a single outlet connected only to an inlet of one of said eductors flowing water and drawing chemical into said flowing water when said respective valve is opened.

29. Treatment apparatus as in claim 28 wherein water at one inlet to an eductor is at a pressure of 20 psi to 90 psi.

30. Treatment apparatus as in claim 29 wherein each eductor has a discharge outlet for treated water operably connected to a water line having water therein at a pressure of 25 psi to 45 psi.

31. Treatment apparatus for a water system including a closed water line for conducting water throughout the system and including chemical additive apparatus operably coupled in said line for adding water-treating chemical to treat water in said line, and further including:
an eductor operably connected to said water line and having an upstream water inlet connected to said line and a downstream water outlet connected to said line;
said eductor having a chemical inlet suction port operably connected to a chemical supply for drawing chemical into water flowing through said eductor; and
a valve for directing water flow in said water line selectively through or around said eductor at a pressure of about 20 psi to about 90 psi.

32. Treatment apparatus as in claim 31 wherein said eductor has a discharge outlet operably connected to a water line having water therein at a pressure of 25 psi to 45 psi.

33. Treatment apparatus for a water system and comprising:
at least one eductor having an inlet operably connected to a water source through a respective valve having a single outlet connected to said inlet;
said eductor having a chemical inlet through which chemical is drawn from a chemical source into water flowing through said eductor;
said eductor having a discharge outlet for discharging chemically treated water flowing from said eductor, into a water system;
means for controlling said valve in response to a condition of water in said water system;
said valve and eductor connected in said system independently of said controlling means.
